(19) United States
(12) Patent Application Publication
(10) Pub. No.: US 2018/0017939 A1
(43) Pub. Date: Jan. 18, 2018

(54) DEVICE FOR OBSERVING A SAMPLE

(71) Applicant: Commissariat a l'energie atomique et aux energies alternatives, Paris (FR)

(72) Inventors: Cedric ALLIER, Grenoble (FR); Thomas BORDY, Grenoble (FR); Francois TEMPLIER, Grenoble Cedex (FR)

(73) Assignee: Commissariat a l'energie atomique et aux energies alternatives, Paris (FR)

(21) Appl. No.: 15/648,996

(22) Filed: Jul. 13, 2017

(30) Foreign Application Priority Data
Jul. 13, 2016 (FR) 16 56751

(51) Int. Cl. G03H 1/04

(52) U.S. Cl. CPC G03H 1/0465; G03H 1/0443; G03H 1/0404; G03H 2222/24

(57) ABSTRACT

The invention relates to a device for observing a sample, including:
a light source able to emit an incident light wave that propagates towards a holder able to receive the sample; and
an image sensor able to detect a light wave transmitted by the sample when the latter is placed between the light source and the image sensor.

The device is characterized in that the light source includes a light-emitting diode that is what is called micron-sized, a light-emission surface of which has a diameter or a largest diagonal smaller than 500 μm.

The invention also relates to a method for observing a sample using such a device.

### FIELD OF THE INVENTION

The technical field of the invention is the observation of samples by formation of a hologram of the sample using an image sensor.

### BACKGROUND

The observation of samples, and in particular biological samples, by lensless imaging has undergone substantial development over the last ten years. This technique allows a sample to be observed by placing it between a light source and an image sensor, without placing a magnifying optical lens between the sample and the image sensor. Thus, the image sensor collects an image of a light wave transmitted by the sample.

This image is formed from interference patterns formed by interference between the light wave emitted by the source and transmitted by the sample and diffracted waves resulting from the diffraction by the sample of the light wave emitted by the source. These interference patterns are sometimes called diffraction patterns. The image formed on the image sensor may be processed using a numerical propagation algorithm, so as to estimate optical properties of the sample. Such algorithms are well known in the field of holographic reconstruction. To do this, the distance between the sample and the image sensor being known, a holographic reconstruction algorithm taking into account this distance is applied. The publication Garcia-Sucerquia J., “Digital in-line holographic microscopy”, Applied Optics, Vol. 45, No. 5, 10 Feb. 2006, describes the observation of particles, for example biological particles, using a laser beam, and the application of reconstruction algorithms to images formed on a CCD sensor.

Document WO2008090330 has shown that it is possible to replace the laser light source with a spatially filtered light-emitting diode and still obtain an exploitable image of biological samples, in the present case cells, by lensless imaging. The device described in this document allows an interference pattern to be associated with each cell, the morphology of the interference pattern associated with each cell allowing the type of cell to be identified. Other publications have followed, confirming the advantageousness of such a technology, for example patent application US2012/0218379. In these publications, the devices described comprise a spatial filter between the light source and the sample. The spatial filter defines an aperture the diagonal or the diameter of which is comprised between a few tens of μm and about 200 μm.

The inventors have observed that the presence of such a spatial filter leads to certain drawbacks. Firstly, it requires that the light source be precisely centred with respect to the aperture that it defines. In addition, this centration must remain precise during use of the device, and in particular during handling or transportation thereof. Moreover, the presence of a spatial filter presupposes a compromise with respect to the aperture of the filter. A small aperture allows a good spatial coherence to be obtained but considerably limits the solid angle of emission of the incident light wave, thereby decreasing the amount of light reaching the detector. This is detrimental to the sensitivity of the measurement. The inventors provide a device allowing these drawbacks to be remedied.

### SUMMARY

One subject of the invention is a device for observing a sample, including:
a light source able to emit an incident light wave that propagates towards a holder able to receive the sample; and
an image sensor able to detect a light wave transmitted by the sample when the latter is placed between the light source and the image sensor;
wherein the light source includes a light-emitting diode that is what is called micron-sized, a light-emission surface of which has a diameter or a largest diagonal smaller than 500 μm.

Preferably, the emission surface of the micron-sized light-emitting diode has a diameter or a largest diagonal smaller than 150 μm or than 50 μm or than 10 μm.

According to one embodiment, the light source includes a plurality of micron-sized light-emitting diodes. The micron-sized light-emitting diodes can be arranged in a matrix array, the diodes being spaced apart from one another by a distance smaller than 50 μm. The micron-sized light-emitting diodes may then be activated simultaneously or independently of one another or successively.

Another object of the invention is a method for observing a sample, including the following steps:
placing a sample between a light source and an image sensor in such a way that the image sensor is configured to acquire an image of the sample when the sample is illuminated by the light source; and
illuminating the sample with the light source and acquiring an image of the sample with the image sensor;

wherein:
the light source includes at least one micron-sized light-emitting diode defining an emission surface, a largest diameter or a largest diagonal of which is smaller than 500 μm, and more preferably smaller than 150 μm or than 50 μm;
no magnifying optics are placed between the sample and the image sensor.

Preferably, the micron-sized light emitting diode has an optical emission power higher than 50 μW.

According to one embodiment, the light source includes a plurality of micron-sized light-emitting diodes. The micron-sized light-emitting diodes can be activated successively, the image sensor acquiring one image during each successive activation. The micron-sized light-emitting diodes may in particular have spectral emission bands that are different from one another. In the latter case, the image sensor may acquire one image during each successive activation.

According to one embodiment, the image sensor lies in a detection plane and the method includes applying a propagation operator to the acquired image, or to each acquired image, so as to obtain a complex expression of a light wave to which the image sensor is exposed, in a reconstruction plane located at a nonzero distance from the detection plane. The reconstruction plane may be a plane in which the sample lies.

The method may in particular be implemented using the device described in this description.

Other advantages and features will become more clearly apparent from the following description of particular embodiments of the invention, which are given by way of nonlimiting example, and shown in the drawings listed below.

### BRIEF DESCRIPTION OF THE DRAWINGS

FIG. 1A shows a device for observing a sample according to the prior art.

FIG. 1B illustrates one of the difficulties encountered in the prior art.

FIG. 1C shows another device for observing a sample according to the prior art.

FIG. 2 shows a device for observing a sample according to the invention.

FIG. 3 shows an example of a light source usable in a device according to the invention.

FIG. 4A shows another example of a matrix-array light source usable in a device according to the invention. FIG. 4B shows the variation in the emission power of an elementary light-emitting diode of this light source as a function of the size of a supply current.

FIGS. 5A and 5B show reconstructed images obtained by applying a holographic reconstruction algorithm to an image acquired by an image sensor using a prior-art device and a device according to invention, respectively.

### DETAILED DESCRIPTION OF THE ILLUSTRATED EMBODIMENTS

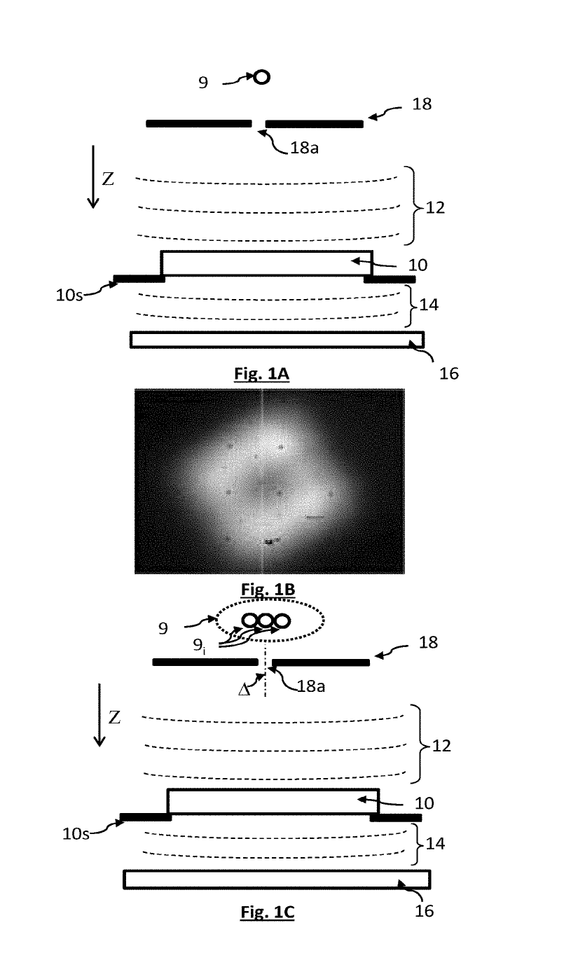

FIG. 1A shows a device for observing a sample by lensless imaging according to a prior-art device. A light source 9, for example a light-emitting diode, emits an incident light wave 12 that illuminates a sample 10 held by a holder 10s. On passing through the sample, the incident light wave forms what is called a transmitted wave 14 that propagates towards an image sensor 16. The image sensor is able to form an image of the sample 10, which image is designated by the term “hologram”. The absence of magnifying optics between the sample 10 and the image sensor 16 will be noted. The device also includes a spatial filter 18, having an aperture 18a with respect to which the light source 9 is centred. Generally, a spatial filter corresponds to an opaque surface in which a transparent aperture 18a is provided. In document US2012/0218379, the diameter of the aperture 18a is about 50 μm to 100 μm. The function of this spatial filter is to define a spatial coherence of the light source.

Preferably, the incident light wave has a narrow spectral band, for example narrower than 50 nm, so as to improve temporal coherence. An optical passband filter may be placed between the light source 9 and the spatial filter 18. This allows the often mediocre temporal coherence of a light-emitting diode to be compensated for.

However, the inventors have observed that the presence of such a spatial filter leads to drawbacks, in particular when the light source is a light-emitting diode. In such a case, the intensity of the incident wave 12 reaching the image sensor 16 may not be uniform. Specifically, the geometry of the light-emitting diode is projected, through the spatial filter, onto the image sensor 16, in the same way that it would be in a pinhole photographic device. FIG. 1B illustrates an image obtained using a device such as that schematically shown in FIG. 1A, the light source being a light-emitting diode located at a distance of about 5 cm from the image sensor 16, in the absence of sample between the light source and image sensor. It may be seen that in the illuminated portion of the image, the illumination is not uniform, this being detrimental to the quality of the results obtained. In addition, the depth of field of a pinhole-type optical configuration being infinite, this nonuniform illumination is obtained whatever the distance between the light source and the sensor.

Another drawback associated with the use of a spatial filter 18 is the centration of the light source with respect to the aperture 18a defined by this filter. This problem is all the larger given that certain devices include a light source 9 comprising a plurality of elementary light sources 9, that are adjacent to one another and that are able to be activated successively, as is shown in FIG. 1C. It is difficult to optimize the centration of each elementary light source with respect to the aperture 18a. Thus, certain elementary light sources are centred, i.e. placed on a central axis A of the aperture 18a, whereas others are not.

A solution exists, consisting in inserting an optical scatterer between the light-emitting diode and the spatial filter, but this increases the price of the device.

Moreover, the insertion of a spatial filter between a light-emitting diode and a sample drastically decreases the illumination of the sample, the latter being exposed only to a small portion of the light wave emitted by the light-emitting diode. This drawback is particularly crucial when the sample contains moving particles, requiring an image to be acquired with a very short exposure time, typically of about 100 ms. Moreover, in such a configuration, it is difficult to insert a passband filter between the light-emitting diode and the sample, because it generates too great an attenuation of the incident wave 12.

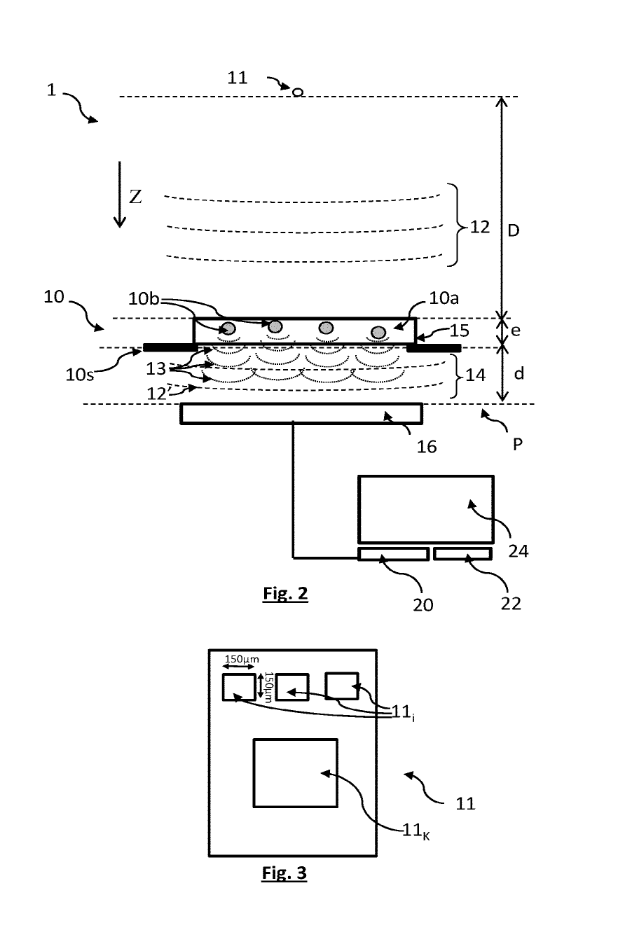

The inventors, having noted these problems, have designed a device 1 such as shown in FIG. 2. In this device, the light source 11 includes a light-emitting diode the diameter or largest diagonal of which is smaller than 500 μm, and preferably smaller than 100 μm, or even than 50 μm or 10 μm. Such a light-emitting diode is designated by the term “micron-sized diode” or “microdiode”. It emits a light wave 12, called the incident light wave, that propagates in the direction of a sample 10, along a propagation axis Z. The light wave is emitted in a spectral band Δλ, including a wavelength λ. This wavelength may be a central wavelength of the spectral band Δλ.

The sample 10 is a sample that it is desired to characterize. It may in particular be a question of a medium 10a containing particles 10b. The particles may be cells, microorganisms, for example bacteria or yeasts, microalgae, microbeads, or droplets that are insoluble in the liquid medium, for example lipid nanoparticles. Preferably, the particles 10b have a diameter, or are inscribed in a diameter, smaller than 1 mm and preferably smaller than 100 μm. It is a question of microparticles (diameter smaller than 1 mm) or nanoparticles (diameter smaller than one μm). The medium 10a, in which the particles are suspended, may be a liquid medium, for example a liquid phase of a bodily fluid, a culture medium or a liquid sampled from the environment or from an industrial process. It may also be a question of a solid medium or a medium having the consistency of a gel, for example an agar substrate, favourable to the growth of bacterial colonies. The sample may also be a tissue slide intended for a histological analysis, or an anatomopathological slide, including a thin thickness of tissue deposited on a transparent slide. The expression “thin thickness” is understood to mean a thickness that is preferably smaller than 100 μm, more preferably smaller than 10 μm and typically a few microns.

The sample 10 is held by a holder 10s. It may be contained in a fluidic chamber 15 or deposited on a transparent slide. The thickness e of the sample 10, along the propagation axis Z, typically varies between 20 μm and 1 cm, is preferably comprised between 50 μm and 500 μm and for example is 150 μm.

The distance D between the light source 11 and the sample 10 is preferably larger than 1 cm. It is preferably comprised between 2 and 30 cm, and preferably comprised between 2 and 5 cm or 10 cm. Preferably, the light source, seen by the sample, may be considered to be point-like. Preferably, the spectral emission band Δλ of the incident light wave 12 has a band width smaller than 100 nm. By band width of the spectral band, what is meant is a full width at half-maximum of said spectral band. Such a spectral band may be obtained by way of a passband filter inserted between the light source 11 and the sample 10.

The sample 10 is placed between the light source 11 and an image sensor 16. The latter preferably lies parallelly or substantially parallelly to the plane in which the sample lies. The expression “substantially parallelly” means that the two elements may not be rigorously parallel, an angular tolerance of a few degrees, smaller than 20° or 10°, being acceptable.

The image sensor 16 is configured to form an image in a detection plane P. In the example shown, it is a question of a CCD or CMOS image sensor including a matrix array of pixels. CMOS sensors are preferred because the size of the pixels is smaller, this allowing images to be acquired the spatial resolution of which is more advantageous. The detection plane P preferably lies perpendicularly to the propagation axis Z of the incident light wave 12.

The distance d between the sample 10 and the matrix array of pixels of the image sensor 16 is preferably comprised between 50 μm and 2 cm and more preferably between 100 μm and 2 mm.

The absence of magnifying optics or image forming optics between the image sensor 16 and the sample 10 will be noted. This does not prevent focusing microlenses from possibly being present level with each pixel of the image sensor 16, the function of said lenses not being to magnify the image acquired by the image sensor.

When illuminated by the incident light wave 12, the sample 10 may generate a diffracted wave 13 that is liable to produce, in the detection plane P, interferences, in particular with a portion 12′ of the incident light wave having passed through the sample. Moreover, the sample may absorb some of the incident light wave 12. Thus, generally, and whatever the embodiment, the light wave 14 transmitted by the sample, and to which the image sensor 16 is exposed, may comprise:
a diffraction component 13 resulting from the diffraction of the incident light wave 12 by the sample; and
a component 12′ resulting from the absorption of the incident light wave 12 by the sample.

FIG. 2 shows a wave 13 diffracted by each particle 10b composing the sample, and the light wave 12′ resulting from the absorption by the sample of part of the incident light wave 12.

A processor 20, for example a microprocessor, is configured to process each image acquired by the image sensor 16. In particular, the processor is a microprocessor connected to a programmable memory 22 in which is stored a sequence of instructions that it may follow to carry out its image-processing operations. The processor may be coupled to a screen 24 allowing images acquired by the image sensor 16 or computed by the processor 20 to be displayed.

In certain cases, the image acquired by the image sensor 16, also called a hologram, does not allow a sufficiently precise representation of the observed sample to be obtained. It is possible to apply, to each image acquired by the image sensor, a propagation operator h, so as to calculate a quantity representative of the light wave 14 transmitted by the sample 10, i.e. of the light wave to which the image sensor 16 is exposed. Such a method, designated by the expression “holographic reconstruction”, in particular allows a complex expression A of the light wave 14 to be calculated. It is thus possible to reconstruct an image of the modulus or of the phase of this light wave 14 in a reconstruction plane located at a nonzero distance from the detection plane, the reconstruction plane preferably being parallel to the detection plane P and in particular a plane in which the sample lies. Such algorithms are known to those skilled in the art. An example thereof may be found in US 2012/0218379, or even in patent application FR1554811 filed 28 May 2015.

A holographic reconstruction method in particular includes applying a convolution to an image I acquired by the image sensor 16 via a propagation operator h. It is then possible to reconstruct a complex expression A of the light wave 14 at any point of spatial coordinates (x, y, z), and in particular in a reconstruction plane P_{z} located at a nonzero distance |z| from the image sensor 16, this reconstruction plane possibly being a plane in which the sample lies. The complex expression A is a complex quantity the argument and modulus of which are representative of the phase and intensity of the light wave 14 to which the image sensor 16 is exposed, respectively. The convolution of the image I with the propagation operator h allows a complex image A_{z} representing a spatial distribution of the complex expression A in the reconstruction plane P_{z}, lying at a coordinate z from the detection plane P, to be obtained. This complex image corresponds to a complex image of the sample 10 in the reconstruction plane P_{z}. The function of the propagation operator h is to describe the propagation of light between the image sensor 16 and a point of coordinates (x, y, z) located at a distance |z| from the image sensor. It is then possible to determine the modulus M(x, y, z) and/or the phase φ(x, y, z) of the light wave 14, at said distance |z|, which is called the reconstruction distance, where:

M(x, y, z)=abs [A(x, y, z)] (1)

φ(x, y, z)=arg [A(x, y, z)] (2)

the operators abs and arg designating the modulus and argument, respectively.

In other words, the complex amplitude A of the light wave 14 at any point of spatial coordinates (x, y, z) is such that: A(x, y, z)=M(x, y, z)e^{jφ(x, y, z)} where A=I*h where * designates the convolution operator.

The inventors have shown that with a micron-sized light-emitting diode such as defined above the incident light wave 12 that reaches the sample is sufficiently intense and sufficiently coherent to form an exploitable image of the sample. The image acquired by the image sensor is exploitable as such, or is the subject of a holographic reconstruction algorithm such as described above. The intensity of this wave, in a plane perpendicular to its propagation axis, is more uniform than in the prior art, because of the absence of spatial filter defining a narrow aperture between the light source 11 and the sample 10. By narrow aperture, what is meant is an aperture the diagonal or diameter of which is smaller than 5 mm or 1 mm.

The absence of such a filter also allows the illumination of the sample to be increased. Such micron-sized light-emitting diodes are commercially available at competitive prices. The use of micron-sized light-emitting diodes allows the distance between the light source 11 and the sample 10 to be decreased, said distance possibly being lowered to 5 cm, or even to less than 5 cm. This allows particularly compact devices to be obtained.

Moreover, the absence of a spatial filter makes it possible to avoid placing constraints on the centration of the light source with respect to a narrow aperture formed in the filter.

FIG. 3 schematically shows a light source 11 including three elementary micron-sized diodes 11i, the emission surface of each diode forming a square of 150 μm side-length. This light source is sold by Osram under the reference SFH 7050. Each elementary diode emits in a spectral band Δλ that is different from the others, in the present case 950 nm±60 nm, 660 nm±70 nm, and 525 nm±34 nm, the optical emission power being comprised between 2.9 mW and 6.5 mW. These elementary micron-sized diodes may be activated successively, this allowing images of the sample to be successively acquired in various spectral bands Δλ. Such an acquisition, which is what is called a multispectral acquisition, allows a reconstruction algorithm to be applied to each acquired image, such as described in the publication S. N. A. Morel, A. Delon, P. Blandin, T. Bordy, 0. Cioni, L. Hervé, C. Fromentin, J. Dinten, and C. Allier, “Wide-Field Lensfree Imaging of Tissue Slides,” in Advanced Microscopy Techniques IV; and Neurophotonics II, E. Beaurepaire, P. So, F. Pavone, and E. Hillman, eds., Vol. 9536 of SPIE Proceedings (Optical Society of America, 2015), referred to as “Morel 2015” below.

In this example, the light source 11 also includes a photodiode 11_{K} that is able to detect an intensity of ambient light or of light reflected by the sample when the latter is placed in darkness. This allows an emission power of one or more elementary light-emitting diodes 11ᵢ to be adjusted.

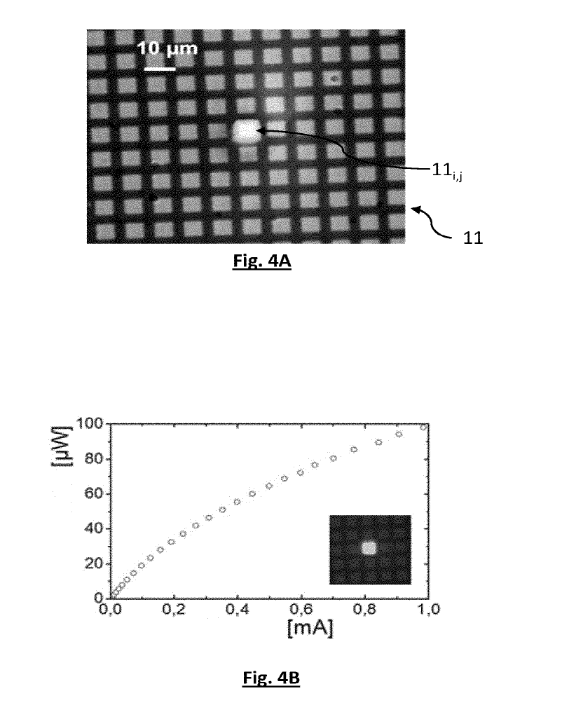

According to another example, shown in FIG. 4A, the light source 11 includes elementary micron-sized light-emitting diodes 11ᵢⱼ that are arranged in a matrix array, for example a regular two-dimensional matrix array. Such a matrix array, which is designed for use in miniature display screens, is described in French patent application FR3016463 or in the publication “Monolithic LED arrays, next-generation smart lighting sources”, Proc. SPIE 9768, Light-Emitting Diodes: Materials, Devices, and Applications for Solid State Lighting XX, 97680X (Mar. 8, 2016).

Each elementary diode has an emission surface describing a square of 6.5 μm side-length. The centre-to-centre distance of each elementary diode is 10 μm. Such a matrix array may include several tens to several hundred elementary diodes 11ᵢⱼ, for example 320×252 elementary diodes. FIG. 4B shows the optical emission power of an elementary diode as a function of a size of its supply current, in a spectral band centred on 440 nm. The optical power may exceed 50 μW, this allowing exploitable images to be formed when the light source is a few centimetres distance from the sample. Such a power level allows a passband filter to be inserted between the light source and the sample, so as to decrease the width of the spectral band Δλ of the incident wave 12, this allowing its temporal coherence to be optimized.

The spectral emission band of each elementary light-emitting diode 11ᵢⱼ may be adjusted, in such a way that various elementary diodes emit in various spectral bands, respectively. This makes it possible to apply a reconstruction algorithm based on the successive acquisition of images of the sample acquired in various spectral bands, as for example described in “Morel 2015”.

The inventors have applied such an algorithm, described in particular in paragraph 2.3 of this publication, to the observation of a test pattern. To do this, first images and second images were acquired using a device such as shown in FIG. 1C, representative of the prior art, and a device such as shown in FIG. 2, using the light source described with reference to FIG. 3, respectively. In each device, a monochromatic CMOS sensor was used. The test pattern was the test pattern known as the USAF test pattern, which includes opaque strips, and was placed at a distance of 1 mm from the image sensor 16.

In a first trial, representing the prior art, a device such as shown in FIG. 1C was employed, the light source being a light-emitting diode manufactured by CREE under the reference XLamp MCE. The three elementary light-emitting diodes 91, 92 and 93 of this light source were successively activated, so as to acquire three images I_{λ} representative of each spectral band Δλ, respectively. In a second trial, a device such as shown in FIG. 2 was employed, the light source used being the Osram light source described with reference to FIG. 3. The three microdiodes 11₁, 11₂ and 11₃ composing it were successively activated so as to acquire three images I_{λ} representative of each spectral band Δλ, respectively. In each trial, the distance between the light source and the sample was about 5 cm, the protocol followed being:
to acquire three images I_{λ}, the sample being successively illuminated in the three illumination spectral bands described above;
to apply an iterative propagation-back propagation algorithm such as described in the publication “Morel 2015” to each image I_{λ}, this algorithm also being described in patent application FR1554811 filed 28 May 2015, and more precisely in steps 100 to 500 described in this patent application, so as to obtain, in each spectral band, a complex amplitude A_{λ}(x, y, z) of the light wave 14 to which the image sensor is exposed, in a reconstruction plane corresponding to the plane in which the test pattern is placed, i.e. at a distance of 1 mm from the image sensor;
to calculate the modulus M_{λ}(x, y, z) of the complex amplitude A_{λ}(x, y, z) resulting from the algorithm in the reconstruction plane and in each spectral band; and
to determine the average value of the moduli M_{λ}(x, y, z) thus calculated in each spectral band, so as to obtain an image representing the average value of these moduli, called the modulus image.

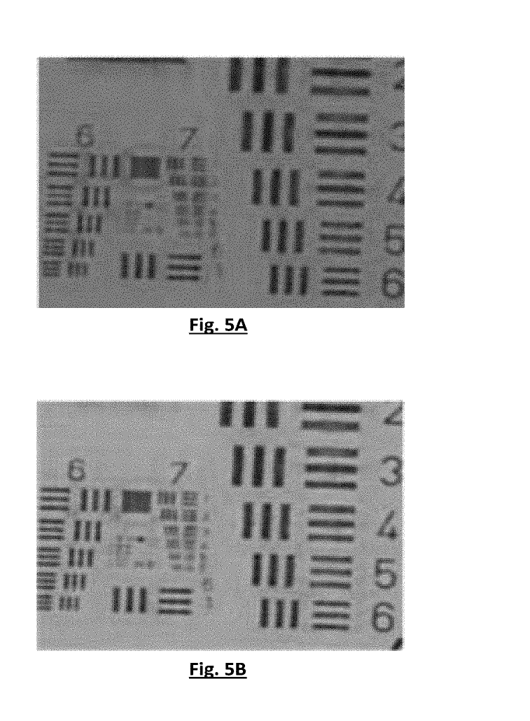

FIG. 5A shows a modulus image obtained in the first trial, representing the prior art. FIG. 5B shows a modulus image obtained in the second trial, representing the invention.

The resolution obtained implementing the invention is better than the resolution obtained according to the prior art (1.9 μm versus 2.2 μm).

Thus, the invention allows a representation of a sample, whether it be an acquired image or an image obtained by applying a holographic reconstruction operator to the acquired image, to be obtained using a simple and inexpensive light source and without there being a need to insert a spatial filter between the sample and the light source.

The invention will possibly be used to observe samples such as biological tissues, biological particles or other particles, so as to characterize samples in the fields of healthcare or of other industrial applications, for example of environmental-control or food-processing applications.

1. A Device for observing a sample, including:
a light source able to emit an incident light wave that propagates towards a holder, the holder being configured to the sample; and
an image sensor configured to detect a light wave transmitted by the sample when the sample is placed between the light source and the image sensor;
wherein:
the light source includes a micron-sized light-emitting diode, a light-emission surface of which has a diameter or a largest diagonal smaller than 500 μm;
no magnifying optics are placed between the sample and the image sensor;
the micron-sized light emitting diode has an optical emission power higher than 50 μW.

2. The Device according to claim 1, wherein the emission surface of the micron-sized light-emitting diode has a diameter or a largest diagonal smaller than 150 μm or than 50 μm or than 10 μm.

3. The Device according to claim 1, wherein the light source includes a plurality of micron-sized light-emitting diodes.

4. The Device according to claim 3, wherein the micron-sized light-emitting diodes are arranged in a matrix array, the diodes being spaced apart from one another by a distance smaller than 50 μm.

5. The Device according to claim 3, wherein the micron-sized light-emitting diodes have emission spectral bands that are different from one another and are able to be activated successively or simultaneously.

6. The Device according to claim 3, wherein the micron-sized light-emitting diodes are configured to be activated independently of one another.

7. A Method for observing a sample, including the following steps:
placing a sample between a light source and an image sensor in such a way that the image sensor is configured to acquire an image of the sample when the sample is illuminated by the light source; and
illuminating the sample with the light source and acquiring an image of the sample with the image sensor;
wherein:
the light source includes at least one micron-sized light-emitting diode defining an emission surface, a largest diameter or a largest diagonal of which is smaller than 500 μm;
no magnifying optics are placed between the sample and the image sensor;
the micron-sized light emitting diode has an optical emission power higher than 50 μW.

8. The Method according to claim 7, wherein the largest diameter or largest diagonal of the micron-sized light-emitting diode is smaller than 150 μm or than 50 μm.

9. The Method according to claim 7, wherein the light source includes a plurality of micron-sized light-emitting diodes.

10. The Method according to claim 9, wherein the micron-sized light-emitting diodes are activated successively, the image sensor acquiring one image during each successive activation.

11. The Method according to claim 9, wherein the micron-sized light-emitting diodes have spectral emission bands that are different from one another.

12. The Method according to claim 9, wherein, the image sensor lies in a detection plane and wherein the method includes applying a propagation operator to each acquired image, so as to obtain a complex expression of a light wave to which the image sensor is exposed, in a reconstruction plane, the reconstruction plane being located at a nonzero distance from the detection plane.

13. The Method according to claim 12, wherein the reconstruction plane is a plane in which the sample lies.
